(19) United States
(12) Patent Application Publication
(10) Pub. No.: US 2003/0084431 A1
(43) Pub. Date: May 1, 2003

(54) Intermediate code execution system, intermediate code execution method, and computer program product for executing intermediate code

(76) Inventor: Tetsuyuki Kobayashi, Tokyo (JP)

Correspondence Address: Ararat Kapouytian, Morrison & Foerster LLP, 425 Market Street, San Francisco, CA, 94105-2482, US

(21) Appl. No.: 10/283,473

(22) Filed: Oct. 29, 2002

(30) Foreign Application Priority Data
Oct. 31, 2001 (JP) 2001-334822

(51) Int. Cl. G06F 9/45

(52) U.S. Cl. 717/146; 717/139

(57) ABSTRACT

An intermediate code execution system which has processing modules which execute each of processing commands included in a predetermined command system and sequentially interprets and executes intermediate codes written in accordance with the command system comprises a command acquisition portion which takes out a processing command from the intermediate code, a first processing command execution portion which makes judgment upon whether that processing command corresponds to each of selected processing commands selected from processing commands included in the command system, and selects and executes the processing module corresponding to the selected processing command if the taken-out processing command corresponds to that selected processing command, and a second processing command execution portion which specifies a type of a processing command which has not been executed in the first processing command execution portion, and selects and executes the processing module corresponding to that processing command.

### CROSS-REFERENCE TO RELATED APPLICATIONS

This application is based upon and claims the benefit of priority from the prior Japanese Patent Application No. 2001-334822, filed Oct. 31, 2001, the entire contents of which are incorporated herein by reference.

### BACKGROUND OF THE INVENTION

1. Field of the Invention

For the purpose of providing a program which does not depend on a platform of a computer such as hardware or an OS, there has been proposed a method of constructing a virtual machine (VM) on each platform by a software technique or a hardware technique and executing an intermediate code between a source code and an object code on the virtual machine. As one of program languages adopting such a method, there is Java (R) adopting a form of the intermediate code called a class file. It is to be noted that the hardware and the virtual machine constructed on the hardware may be collectively referred to as an intermediate code execution system hereinafter.

2. Description of the Related Art

According to the above-described method, since a single program code can be supplied to various platforms and executed, it is no longer necessary to prepare an object code which can be executed only on each platform. As a result, not only distribution of the program can be simplified, but software development can be made efficient. Therefore, the virtual machine has been constructed in platforms of various computers. Further, in recent years, construction of the virtual machine on a processor has been also started in various electronic devices (which will be referred to as an assembled device hereinafter) having a processor mounted therein.

Here, as the virtual machine, there is known one which is of an interpreter type which is constructed on the platform in the form of software and sequentially interprets and executes byte code commands included in a class file. The interpreter type virtual machine requires a process of taking out byte code commands one by one from the class file and interpreting their contents. This process becomes the overhead in the prior art, and the excellent performance can not be hence obtained.

Thus, there has been proposed a JIT compiler (Just In Time Compiler) system, an AOT compiler (Ahead Of Time Compiler) or the like which compiles the class file into a native code inherent to each hardware and the executes it for the purpose of improving the performance. Furthermore, there has been attempted construction of the virtual machine in the form of hardware like a Java chip which is specially designed to enable direct execution of byte code commands.

In the compiler system such as JIT or AOT mentioned above, since the native code of the processor is executed, it is superior to the interpreter system when taking notice of only a speed of command execution. The compiler system, however, requires a work area necessary for a compile operation itself or an area for storing the native code which is four- to ten-fold of the size of the class file, and hence a larger quantity of memory is disadvantageously required than in the interpreter system. Such a problem is prominent in the assembled device in which restriction in hardware resources is harder than that in a regular computer in particular. Moreover, when starting compile after directing execution of the class file, the compile operation becomes the overhead, and the sufficient performance may not be possibly obtained.

In addition, according to the Java chip mentioned above, although the class file can be executed with the high performance without performing compile, a large amount of development cost is required in development of such a dedicated chip, and increase in cost of the chip itself is inescapable. Additionally, in view of the fact that version upgrade or bug fix is appropriately performed in language specification according to advancement in technology or needs in the market, there is an aspect that constructing the virtual machine in the form of hardware is not necessarily preferable. In particular, in the virtual machine in the assembled device, adoption of the Java chip is not realistic because of combination of strong demands for reduction in cost and version update of the specification in a short cycle.

As described above, since it is hard to apply the virtual machine such as the compiler system or the Java chip in the assembled device or the like, improvement of the performance in execution of the class file has been desired in the virtual machine having the interpreter system which can execute the compact class file as it is mounted in the form of software which can cope with a change in specification without depending on a special hardware design.

### BRIEF SUMMARY OF THE INVENTION

It is an object of the present invention to improve the performance of an intermediate code execution system which executes an intermediate code by an interpreter system.

To achieve this aim, according to a first aspect of the present invention, there is provided a system which executes by an interpreter an intermediate code obtained by converting a source code created in a predetermined program language, the system comprising: a processor; a first storage portion which is relatively fast; a second storage portion which is relatively slow; a first interpreter module which is stored in the first storage portion and corresponds to a subset of a command set of the program language; and a second interpreter module which is stored in the second storage portion and corresponds to the remaining commands in the command set, wherein the processor judges which one of the subsets to which a command taken out from the intermediate code corresponds by the first interpreter module, executes a corresponding command when it exists in the subset, and specifies which one of the remaining commands the command corresponds to and executes it by the second interpreter module when the corresponding command does not exists in the subset.

According to a second aspect of the present invention, there is provided an intermediate code execution method which executes an intermediate code obtained by converting a source code created in a predetermined program language on a processor to which a relatively fast first storage portion and a relative slow second storage portion are connected, the method comprising: causing the processor to make judgment upon which one of subsets a command taken out from the intermediate command corresponds to by using a first interpreter module corresponding to the subset of a command set of the program language and execute a corresponding command when the corresponding command exists in the subset; and causes the processor to specify which one of the remaining commands the command corresponds to and execute it by using a second interpreter module corresponding to the remaining commands of the command set when the corresponding command does not exist in the subset.

According to a third aspect of the present invention, there is provided a computer program product which executes an intermediate code obtained by converting a source code created in predetermined program language on a processor to which a relatively fast first storage portion and a relatively slow second storage portion are connected, wherein a first interpreter module corresponding to a subset of a command set of the program language is stored in the relatively fast storage portion, the first interpreter module is used to judge which one of the subsets a command taken out from the intermediate code corresponds to and execute a corresponding command when the corresponding command exists in the subset, a second interpreter module corresponding to the remaining commands of the command set is stored in a relatively slow second storage portion, the second interpreter module is used to specify which one of the remaining commands the command corresponds to and execute it when the corresponding command does not exist in the subset.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a conceptual view showing a hardware configuration applicable to a first embodiment according to the present invention;

FIG. 2 is a function block diagram of an intermediate code execution system applicable to the first embodiment according to the present invention;

FIG. 3 is a flowchart illustrating an operation of the intermediate code execution system applicable to the first embodiment according to the present invention;

FIG. 4 is a function block diagram of an intermediate code execution system applicable to a second embodiment according to the present invention; and

FIG. 5 is a flowchart illustrating an operation of the intermediate code execution system applicable to the second embodiment of the present invention.

### DETAILED DESCRIPTION OF THE INVENTION

A first embodiment according to the present invention will be first described with reference to FIGS. 1, 2 and 3.

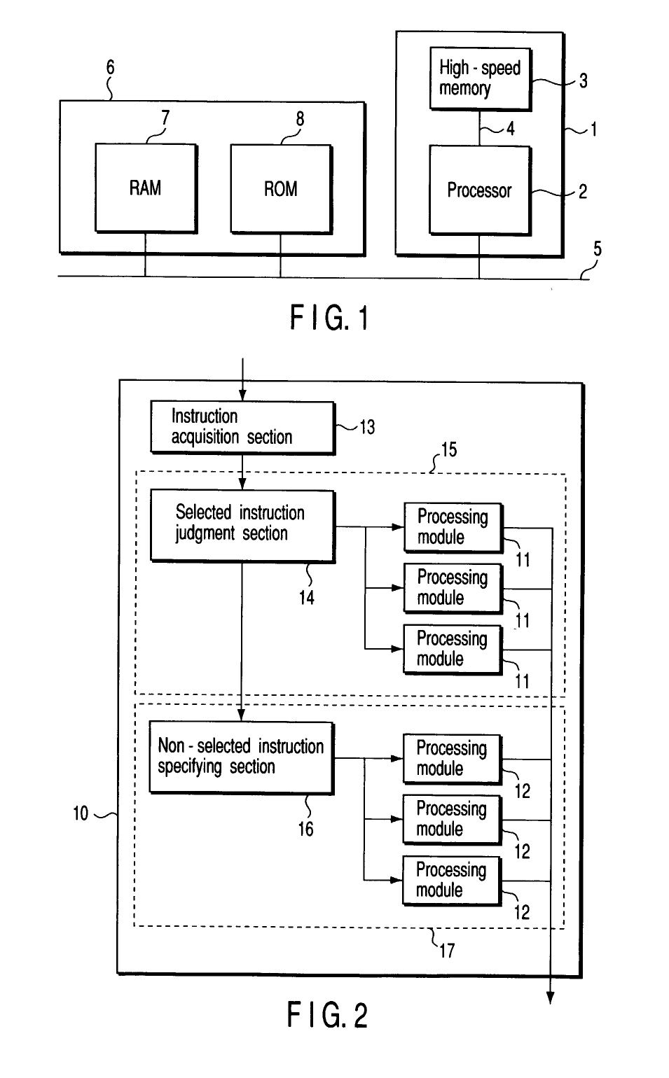

FIG. 1 is a view schematically showing a hardware configuration of an intermediate code execution system 1 according to the first embodiment of the present invention, and FIG. 2 is a function block diagram of the intermediate code execution system 1.

As shown in FIG. 1, the hardware configuration of the intermediate code execution system 1 includes a chip 1 having a processor 2 such as a CPU or an MPU and a high-speed memory 3, and a storage portion 6 having a RAM 7 and a ROM 8. Besides, there may be an input device, a display device, an external interface or the like, but they are not directly related to the structure and effects/advantages of this embodiment and hence omitted.

Here, the processor 2 and the storage portion 6 are connected through an external bus 5, whereas the processor 2 and the high-speed memory 3 are connected through an internal bus 4 having a larger bus width than the external bus 4, and the high-speed memory 3 can transfer data to the processor 2 at a higher speed than that in the storage portion 5. Although an internal memory or a cache memory can be used for such a high-speed memory 3, description will be given as to the case where the internal memory is used in this embodiment.

In the above-described hardware configuration, the intermediate code execution system 1 forming the function block diagram such as shown in FIG. 2 can be realized by executing various kinds of software stored in the storage portion 6 by using the processor 2. The intermediate code execution system 1 executes an intermediate code which does not depend on a platform, and execution of a class file obtained by compiling a source code created in the Java language will be explained in this embodiment. Each function block will now be described.

The intermediate code execution system 1 includes a processing command acquisition portion 13, a first processing command execution portion 15, and a second processing command execution portion 17.

The command acquisition portion 13 sequentially fetches a next command code to be executed from the class file, and the fetched command code is transferred to the first processing command execution portion 15.

The first processing command execution portion 15 includes a selected processing command judgment portion 14 and processing modules 11, and it has a function to sequentially interpret and execute subsets of byte code commands selected from all the byte code commands included in a command system of the Java language. More specifically, in the selected processing command judgment portion 14, a command code taken out by the processing command acquisition portion 13 is compared with each byte code command included in the subset, and the processing module 11 corresponding to the byte code command is executed when they coincide with each other. The processing module 11 is a software program which is provided in accordance with each byte code command included in the subset and causes the processor 2 to execute processing according to a defined content of each byte code command. When there is no same command code in the byte code commands included in the subset, the taken-out command code is transferred to the second processing command execution portion 17.

The second processing command execution portion 17 includes a non-selected processing command specification portion 16 and a processing module 12, and has a function to sequentially interpret and execute byte code commands which are not included in the subset. More specifically, in the non-selected processing command specification portion 16, the taken-out command code is compared with each of the byte code commands which are not included in the subset. Then, when they match with each other, the processing module 12 corresponding to that byte code command is executed. As described above, predetermined processing is executed in the processing module 11 or 12 corresponding to the taken-out command code by combination of the first processing command execution portion 15 and the second processing command execution portion 17.

As described above, in this embodiment, the byte code commands are divided into those executed in the first processing command execution portion 15 and those executed in the second processing command execution portion 17. Here, the byte code commands in the Java (R) language can be roughly divided into four-operation-based commands (iadd, isub, imul, idiv, . . . ) or bit operation-based commands (ior, iand, ishl, . . . ) whose fineness is small, memory operation-based command (iload, istore, iaload, . . . ) whose fineness is medium, and Java-peculiar commands (new, invokespecial, . . . ) whose fineness is large. Further, there is generally a tendency that a frequency of appearance in the class file is high in commands whose fineness is small and it is low in commands whose fineness is large.

Thus, in this embodiment, commands whose size is small and appearance frequency is high are selected from all the byte code commands in advance, and the selected byte code commands are executed in the first processing command execution portion 15, and the remaining byte code commands are executed in the second processing command execution portion 17. That is, the first processing command execution portion 15 has the processing module 11 corresponding to each of the selected byte code commands. Furthermore, the selected processing command judgment portion 14 compares an operation code of a given command code with operation codes of the selected byte code commands one by one, and executes the corresponding processing module 11 when they coincide with each other. Moreover, the second processing command execution portion 17 has the processing module 12 corresponding to each of the remaining byte codes. In addition, the non-selected processing command specification portion 16 compares the operation code of the given command code with operation codes of the remaining byte code commands one by one, and executes the processing module 12 when they coincide with each other.

However, a byte code command having a high frequency varies depending on the environment in which the intermediate code execution system 10 is mounted. For example, the case where it is mounted in a mobile phone, the case where it is mounted in a car navigation system and the case where it is mounted in a PDA all have different use objects and use situations, and hence a command with a high frequency in a given environment does not necessary have the high frequency in any other system. Therefore, it is preferable to examine appearance frequencies of the byte code commands in accordance with each environment in which the intermediate code execution system 10 is mounted and select byte code commands to be executed in the first processing command execution portion 15 based on an examination result.

In addition, in this embodiment, a code of the software program constituting the first processing command execution portion 15 having the above-described structure (first interpreter module) executes the class file while the class file is being stored in the high-speed memory 3. For example, the intermediate code execution system 10 may copy a code of the first processing command execution portion 15 to the high-speed memory 3 from the storage portion 6 before executing the class file. In order to achieve this, the number of the selected byte code commands to be executed in the first processing command execution portion 15 is adjusted, and the software program constituting the first processing command execution portion 15 is formed into a size which can be stored in the high-speed memory 3.

On the other hand, a code of the software program constituting the second processing command execution portion 17 (second interpreter module) can be kept being stored in the storage portion 6.

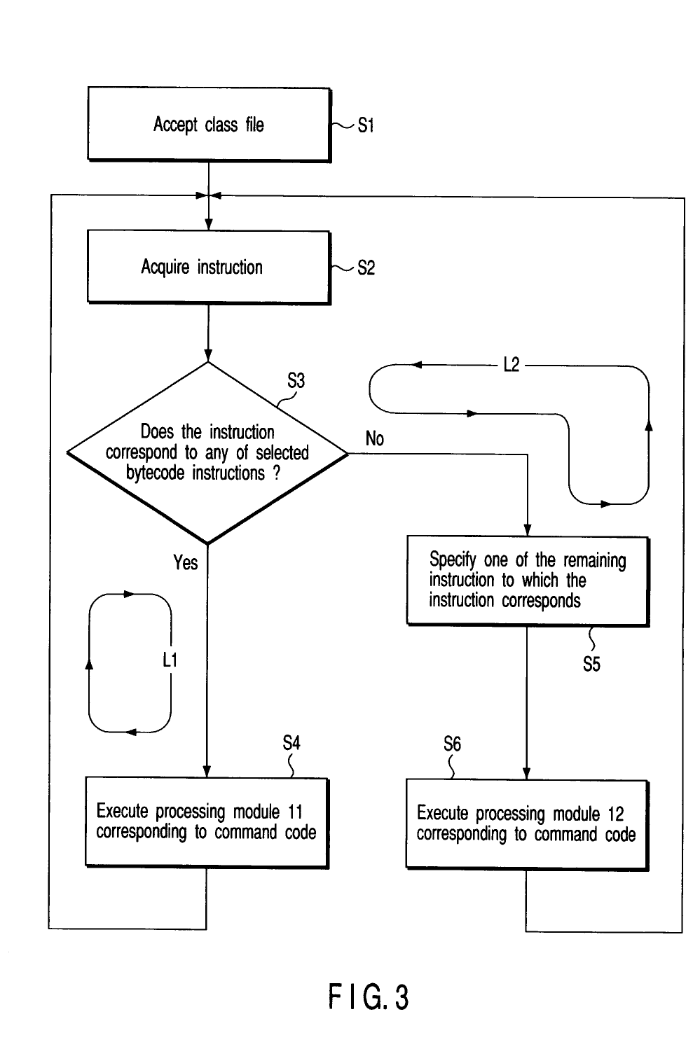

The operation of the intermediate code execution system 10 according to this embodiment will now be described with reference to FIG. 3. Here, the intermediate code execution system 10 has the processing command acquisition portion 13, the first processing command execution portion 15 including the selected processing command judgment portion 14 and the processing module 11, and the second processing command execution portion 17 including the non-selected processing command specification portion 16 and the processing module 12, and they are all constituted by executing a series of software programs stored in the storage portion 6 by the processor 2.

For example, the intermediate code execution system 10 accepts a class file of the Java application from a non-illustrated information input side, and stores the accepted class file in the RAM 7 of the storage portion 6 (S1). Then, the intermediate code execution system 10 executes the software program, and further executes the class file by a series of operations mentioned below. At this moment, the software program constituting the first processing command execution portion 15 (first interpreter module) is kept being stored in the high-speed memory 3 in advance. The following operation is also applied to the intermediate code execution method according to the first embodiment.

The processing command acquisition portion 13 is first constituted by executing the software program by the processor 2, and one command code is taken out from the class file (S2).

Subsequently, the software program constituting the first processing command execution portion 15 (first interpreter module) stored in the high-speed memory 3 is executed, judgment is made upon which one of the selected byte code commands the command code taken out at S2 can be specified to (S3), and the processing module 11 corresponding to the command code is executed if possible (S4). More specifically, the processing executed here is to compare the operation code of the taken-out command code with the operation codes of the selected byte code command one by one in the selected processing command judgment portion 14 in the first processing command execution portion 15 and execute the corresponding processing module 11 when they coincide with each other.

When it is determined to be impossible at S3, namely, it is determined that the operation code of the taken-out command code does not match with any operation codes of the selected byte code commands in the selected-processing command judgment portion 14, the software program constituting the second processing command execution portion 17 (second interpreter module) is executed, one of the remaining byte code commands to which the command code corresponds is specified (S5), and the processing module 12 corresponding to the specified command code is executed (S6). More specifically, the processing executed here is to compare the operation code of the given command code with operation codes of the remaining byte codes one by one in the non-selected processing command specification portion 16 in the second processing command execution portion 17, and the corresponding processing module 12 is executed when they coincide with each other.

Thereafter, the similar procedures are carried out with respect to the next command code included in the class file, and the class file is executed by repeating these procedures.

According to the above-described operation, the byte code commands selected from all the byte code commands are executed by processing forming an inner loup denoted by reference character L1, and the remaining byte code commands are executed by processing forming an outer loup designated by L2.

As described above, in this embodiment, the byte code commands with a small size and a high appearance frequency are first selected from all the byte code command in advance, interpretation and execution of the command codes are carried out in the first processing command execution portion 15 corresponding to the selected byte code commands, and the command codes which has not been executed are then interpreted and executed in the second processing command execution command 17. Therefore, interpretation and execution of the byte code command with the high appearance frequency can be carried out by priority. Additionally, since the software program constituting the first processing command execution portion 15 (first interpreter module) is stored in the high-speed memory 3, the first processing command execution portion 15 can perform interpretation and execution of the byte code command with the high appearance frequency at a high speed. Therefore, according to this embodiment, the byte code commands with the high appearance frequency can be executed at a high speed by priority. On the other hand, since the byte code commands with the low appearance frequency are interpreted and executed by the second processing command execution portion 17, the speed of executing the byte code commands can not be increased. However, the effect of executing the byte code commands with the high appearance frequency by the first processing command execution portion 15 at a high speed by priority is very high, and the performance of the intermediate code execution system 10 can be improved when considering the entire processing executing the class file.

Further, in this embodiment, the software program forming the first processing command execution portion 15 (first interpreter module) may be configured to be optimum for execution of the selected command codes, and the performance of the intermediate code execution system 10 can be further improved by doing so.

For example, both the software program forming the first processing command execution portion 15 (first interpreter module) and the software forming the second processing command execution portion 17 (second interpreter module) may be created by using a high-level language such as C or C++, but the former may be configured to be optimum by using the assembly language.

Furthermore, when the selected processing command judgment portion 14 compares the operation code of the taken-out command code with the operation codes of the selected byte code commands and makes judgment upon whether they coincide with each other, performing comparison in the order from the byte code command with the higher frequency is more preferable. This can be also applied to the non-selected processing command specification portion 16.

In view of the computer program product used to execute the intermediate code, this embodiment is as follows.

That is, there is provided a computer program product which executes an intermediate code obtained by converting a source code created in a predetermined program language on a processor to which the high-speed memory 3 and the storage portion 6 are connected, wherein the first interpreter module corresponding to a subset of a command set of the program language is stored in the high-speed memory 3, the first interpreter module is used to judge whether a command taken out from the intermediate code corresponds to any of the subset, this command is executed when the corresponding command exists in the subset, the second interpreter module corresponding to the remaining commands of the command set is stored in the storage portion 6, and the second interpreter module is used to specify which one of the remaining commands that command corresponds to and execute it when there is no corresponding command in the subset. In this case, it is presumed that the subset of the command set of the program language is previously defined.

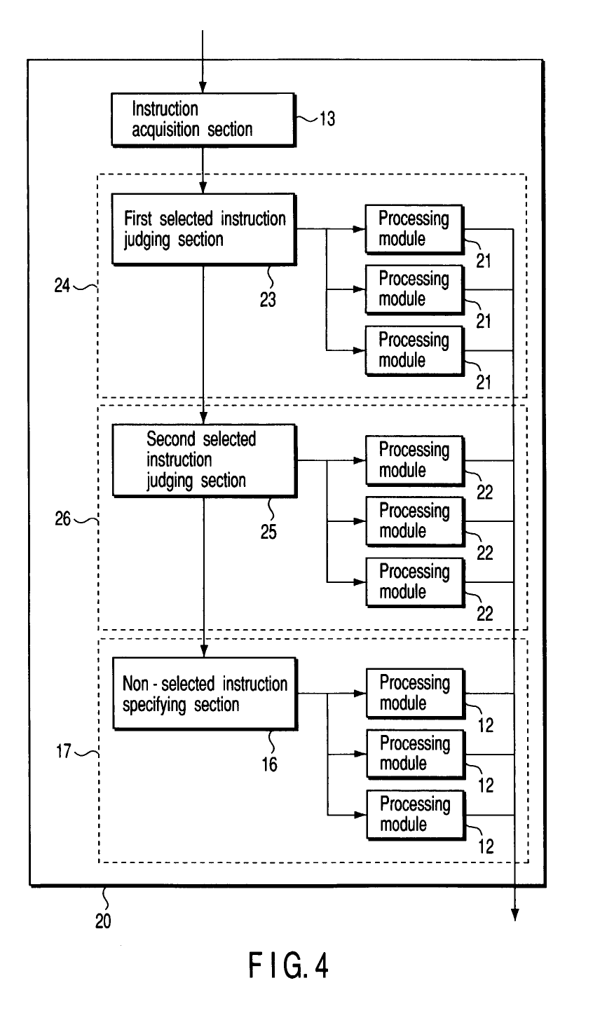

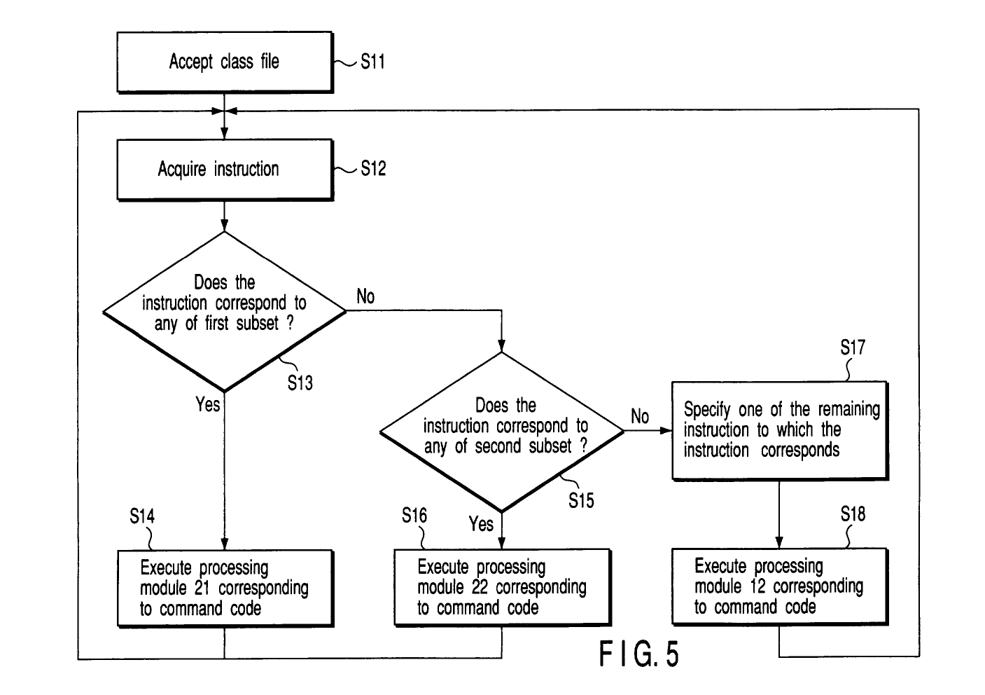

A second embodiment according to the present invention will now be described with reference to FIGS. 4 and 5.

FIG. 4 is a function block diagram of an intermediate code execution system 20 according to the second embodiment of the present invention. In FIG. 4, like reference numerals denote constituent parts equal to those in the first embodiment.

The intermediate code execution system 20 according to the second embodiment is similar to that according to the first embodiment in basic structure, but different from the same in that a first selected processing command execution portion 24 and a second selected processing command execution portion 26 are provided in place of the first processing command execution portion 15 in the first embodiment. Description will be mainly given as to this difference.

The first selected processing command execution portion 24 includes a first selected processing command judgment portion 23 and processing modules 21, and has a function to sequentially interpret and execute a first subset of byte code commands selected from all the byte code commands.

The second selected processing command execution portion 26 includes a second selected processing command judgment portion 25 and processing modules 22, and has a function to sequentially interpret and execute a second subset of byte code commands selected from the remaining byte code commands excluding the first subset.

The processing module 21 is a software program which causes a processor 2 to execute processing according to a defined content of each byte code command belonging to the first subset, and the processing module 22 is a software program which causes the processor 2 to execute processing according to a defined content of each byte code command belonging to the second subset.

Further, concrete functions of the first selected processing command execution portion 24 and the second selected processing command execution portion 26 are substantially similar to that of the processing command execution portion 15 in the first embodiment. When a taken-out command code is the same as any of the byte code commands belonging to the first subset or the second subset, these portions execute that byte code command.

Here, the first subset includes a byte code command having a highest frequency of appearance in a class file, and the second subset includes a byte code command having a second highest frequency of appearance in the class file. Furthermore, in this embodiment, a code of the software program forming the first selected processing command execution portion 24 is stored in a high-speed memory 3. Although it is preferable to store a code of the software program forming the second selected processing command execution portion 26 in the high-speed memory 3 if there is an enough free capacity, it may be stored in a storage portion 6 if the high-speed memory 3 lacks an enough free capacity.

The operation of the intermediate code execution system 20 will now be described with reference to FIG. 5.

Like the first embodiment, the intermediate code execution system 10 first accepts the class file of the Java application from a non-illustrated information input side, stores the accepted class file in a RAM 7 of the storage portion 6 (S11), and executes the class file by the following procedures with the software program forming the first selected processing command execution portion 24 being stored in the high-speed memory 3.

One command code is first taken out from the class file like the first embodiment (S12).

Then, the software program forming the first selected processing command execution portion 24 stored in the high-speed memory 3 is executed, judgment is made upon whether the taken-out command code can be specified as any byte code command in the first subset (S13), and the processing module 21 corresponding to that command code is executed when specification is possible (S14).

When it is determined that specification is impossible at S13, the software program forming the second selected processing command execution portion 17 is executed, judgment is made upon whether the command code can be specified as any byte code command in the second subset (S15), and the processing module 22 corresponding to that command code is executed when specification is possible (S16).

Moreover, if it is determined that specification is impossible at S15, the software program forming the second processing command execution portion 17 is executed, one of the remaining byte code commands to which that command code corresponds is specified (S17), and the processing module 12 corresponding to the specified command code is executed (S18).

The similar procedures are carried out with respect to the next command code included in the class file, and the class file is executed by repeating these procedures.

According to this embodiment which executes the class file with the above-described operation, the byte code command with the highest frequency of appearance in the class file can be executed at a high speed by priority like the first embodiment, and the byte code command with the next highest frequency of appearance in the class file can be executed by priority over any other byte code commands.

In addition, in the above-described operation, although the code of the software program forming the first selected processing command execution portion 24 is stored in the high-speed memory 3 in advance, a free capacity in the high-speed memory 3 may be detected when executing the class file, and the code of the software program forming the second selected processing command execution portion 26 may be likewise stored in the high-speed memory 3 if there is an enough free capacity.

Although the above has described the intermediate code execution system according to the first and second embodiments, the present invention is not restricted to these embodiments, and various improvements/modifications can be naturally made without departing from the scope of the invention.

For example, although the internal memory is provided as the high-speed memory 3 in the foregoing embodiments, the present invention is not restricted thereto, and the high-speed memory 3 may be a cache memory. Additionally, the present invention is not restricted to the example of the hardware configuration shown in FIG. 1, and it is possible to apply any hardware configuration as long as a relatively fast memory and a relatively slow memory are both provided in that configuration. The chip 1 may be, for example, an ASIC or a micro controller, and a structure including a plurality of chips 1 or processors 2 can suffice.

When the cache memory is used as the high-speed memory 3 in the first embodiment, execution of the class file may be started with the code of the software program forming the first processing command execution portion 15 being stored in the storage portion 6. In this case, since the code is stored in the cache memory which is the high-speed memory 3 by a predetermined cache mechanism, the performance of the intermediate code execution system 10 can be improved as with the foregoing embodiments. This is also true in the case of using the cache memory in the second embodiment.

Further, although description has been given as to the case where the class file of Java is executed as the intermediate code in each of the foregoing embodiments, the present invention is not restricted thereto.

Furthermore, the software program forming the intermediate code execution system may be previously stored in the storage portion 6, or it may be provided from the outside of the intermediate execution system according to needs. In this case, the conformation of receiving the software program from the outside of the intermediate code execution system is not restricted to download from a server through a network, and the software may be provided from a storage medium such as a CD-ROM or a portable memory.

Moreover, the performance can be further improved by adopting the structure that at least a part of the processing modules is determined as the hardware logic. For example, by determining the processing module 11 of the first processing command execution portion 15 in the first embodiment as the hardware logic, the byte code command with a high frequency can be executed at a higher speed. In such a case, the number of gates required for realization of the hardware logic can be limited within an allowance by adjusting the number of the byte code commands to be selected.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. A system which executes by an interpreter an intermediate code obtained by converting a source code created in a predetermined program language, comprising:
a processor;
a relatively fast first storage portion;
a relatively slow second storage portion;
a first interpreter module which is stored in the first storage portion and corresponds to a subset of a command set of the program language; and
a second interpreter module which is stored in the second storage portion and corresponds to the remaining commands of the command set,
wherein the processor judges whether a command taken out from the intermediate code corresponds to any of the subset by the first interpreter module, and executes the corresponding command when it exists in the subset, and
specifies any of the remaining commands to which the command corresponds and executes it by the second interpreter module when the corresponding command does not exist in the subset.

2. The system according to claim 1, wherein the predetermined program language is Java language.

3. The system according to claim 1, wherein the intermediate code is a class file including Java byte code commands.

4. The system according to claim 1, wherein the command is a Java byte code command.

5. The system according to claim 1, wherein the subset of the command set of the program language is a set of selected processing commands included in the intermediate code with a predetermined frequency or a higher frequency and it is previously set based on predetermined conditions concerning an execution environment in which the system is mounted.

6. An intermediate code execution method which executes an intermediate code obtained by converting a source code created in a predetermined program language on a processor to which a relatively fast first storage portion and a relatively slow second storage portion are connected, comprising:
causing the processor to make judgment upon which one of subsets to which a command taken out from the intermediate code corresponds by using a first interpreter module corresponding to the subset of a command set of the program language, execute a corresponding command when it exists in the subset;
causing the processor to specify which one of the remaining commands to which the command corresponds and execute it by using a second interpreter module corresponding to the remaining commands of the command set when the corresponding command does not exist in the subset.

7. The method according to claim 6, wherein the predetermined program language is Java language.

8. The method according to claim 6, wherein the intermediate code is a class file including Java byte codes.

9. The method according to claim 6, wherein the command is a Java byte code command.

10. The method according to claim 6, wherein the subset of the command set of the program language is a set of selected processing commands included in the intermediate code with a predetermined frequency or a higher frequency, and it is previously set based on predetermined conditions concerning an execution environment.

11. A computer program product which executes an intermediate code obtained by converting a source code created in a predetermined program language on a processor to which a relatively fast first storage portion and a relatively slow second storage portion are connected,
wherein a first interpreter module corresponding to a subset of a command set of the program language is stored in the relatively fast first storage portion, and the first interpreter module is used to judge whether a command taken out from the intermediate code corresponds to any of the subset and execute a corresponding command when it exists in the subset; and
a second interpreter module corresponding to the remaining commands of the command set is stored in the relatively slow second storage portion, and the second interpreter module is used to specify which one of the remaining commands to which the command corresponds and execute it when the corresponding command does not exist in the subset.

12. The computer program product according to claim 11, wherein the subset of the command set of the program language is a set of selected processing commands included in the intermediate code with a predetermined frequency or a higher frequency, and it is previously set based on predetermined conditions concerning an execution environment.
